(19) United States
(12) Patent Application Publication
(10) Pub. No.: US 2011/0030676 A1
(43) Pub. Date: Feb. 10, 2011

(54) DEVICE FOR A WATER TANK WITH INTEGRATED SOLAR COLLECTOR

(76) Inventor: Meir Levy, Rishon LeZion (IL)

Correspondence Address: DANIEL J SWIRSKY, 55 REUVEN ST., BEIT SHEMESH, 99544, IL

(21) Appl. No.: 12/936,430

(22) PCT Filed: Mar. 19, 2009
(86) PCT No.: PCT/IL09/00311

§ 371 Date: Oct. 5, 2010

(30) Foreign Application Priority Data
Apr. 7, 2008 (IL) 190649

(51) Int. Cl. F24J 2/44

(52) U.S. Cl. 126/639

(57) ABSTRACT

A tank for holding water and incorporated into the tank, in at least one wall of the tank, are a plurality of undulating ridges that act as a solar collector. The tank/collector combination is housed in an insulated container with a glass top double glazed for insulation to prevent heat loss from the tank/collector at night, while not interfering with the radiated solar energy reaching the solar collector of the tank/collector. The material of the tank/collector could be a metal, glass, a type of plastic, transparent material or a combination of more than one material. Option to have a plurality of semi-spherical transparent bodies instead of undulating ridges. Option to have more than one tank/collector connected by a metal pipe that is a good heat conductor.

### FIELD OF THE INVENTION

This invention is in the field of solar energy and in particular a water tank with a portion of its construction a solar collector.

### BACKGROUND OF THE INVENTION

Solar energy water heaters are usually made of two main parts, namely solar collectors and the water tank. This kind of system requires more space for the two bulky components and the tank has to be higher than the collectors for the thermal water flow to operate, otherwise a pump is needed to pump the heated water to the tank.

Space is often a critical factor causing problems with these kind of solar water systems.

What is needed is a system or a device that combines the water tank and the solar collector that do not need one part higher than the other or pumping apparatus. Such a combination also saves lengthy piping needed in prior art to join the tank portion to the solar collector portion and saves having two separate apparatuses namely the water tank and the solar collector.

More over such a device that combines the water tank and the solar collector will also improve the saving in constructions especially in high rise building.

### SUMMARY OF THE INVENTION

It is to be understood that both the foregoing general description and the following detailed description present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention but not to limit the invention to these descriptions only.

This invention reveals a water tank/solar collector comprising a tank for holding water and incorporated into the tank, in the upper face of the tank, are a plurality of ridges alternating with indentations. Alternately, the upper tank face could be made of semi-spherical bodies.

The whole water tank/solar collector would be in an insulated container where the insulation covers the underside and side walls of the water tank/solar collector. The top face of the water tank/solar collector has the surface area increased by means of the undulating ridges and indentations or the semi-spherical bodies. The top face of the insulated container is a glass cover to make a greenhouse effect in the space between the glass cover and the top face of the water tank/solar collector. The glass cover could be double glazed glass or other kind of glass that allows maximum solar energy to enter between the glass and the top face of the water tank/solar collector, while preventing as much as possible, the accumulated heat energy from exiting via the glass cover especially at times when the sun is not shining through the glass.

The energy from the sun is transferred to the water in the water tank/solar collector by conduction of heat from the accumulated heat under the glass, commonly known as the greenhouse effect. The increased surface area of the top face of the water tank/solar collector namely the ridges or the semi-spheres increases the efficiency of this heat conduction process to heat the water in the tank. When the ridges or semi-spheres are made of glass or other transparent material the water in the tank will also be heated by the transfer of radiated energy from the sun directly onto the water in the tank. The semi-spheres, when transparent, may also increase the water heating efficiency by the magnification effect caused by the convex transparent surface.

The water tank/solar collector with its insulated container would be supported facing the sun in an optimal direction and angle to catch the optimal amount of solar energy from the sun.

A lead pipe connected to the lower portion of the tank is used to supply unheated water to the tank. A lead pipe connected to the upper portion of the tank is used to supply heated water to the user.

The water tank could be cylindrical, semi-cylindrical or cuboid.

Undulating ridges and semi-spherical bodies expose a large surface area for collecting solar energy. In addition the dome shape of each semi-spherical body will catch the sun's rays at the optimal angle for high solar radiated energy absorption at all angles of the sun relative to the earth during day-light hours. A majority of the heat that heats the water in the water tank is by the conduction of heat collected under the glass cover of the tank. The greater the surface area of the water tank, the undulating ridges or semi-spherical bodies, the quicker the heat is absorbed into the water. The sun's radiated energy will add to the heat of the water.

The water tank of this invention could have an electrical heating element attached to the tank to heat water in the tank in addition to the solar heating or in place of the solar energy when the sun's energy is concealed.

The tank could have an outer shell made of one or more of the following materials namely metal, plastic, polyurethane compounds, polypropylene or polypropene, also known as PP, polymethyl methacrylate, also known as PMMA and also known as acrylic glass, polyvinylidene difluoride, also known as PVDF, and polyethylene terephthalate, also known as PET.

There could be more than one tank in an insulated container under a sheet of glass.

### BRIEF DESCRIPTION OF THE DRAWINGS

The accompanying drawings, which are incorporated in and form a part of this specification, illustrate embodiments of the invention and together with the description, serve to explain by way of example only, the principles of the invention:

FIG. 1 is a cross section schematic diagram of the water tank/solar collector inside an insulated container.

FIG. 2 is a plan view schematic diagram of the water tank/solar collector.

FIG. 3 is a schematic diagram of the perspective view of the water tank/solar collector.

FIG. 4 is a schematic diagram of the perspective view of the water tank/solar collector with semi-spherical spheres.

FIG. 5 is a schematic diagram of a cross sectional and expanded view of the water tank with semi-spherical spheres.

FIG. 6 is a schematic diagram of two tanks/solar collectors joined together.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

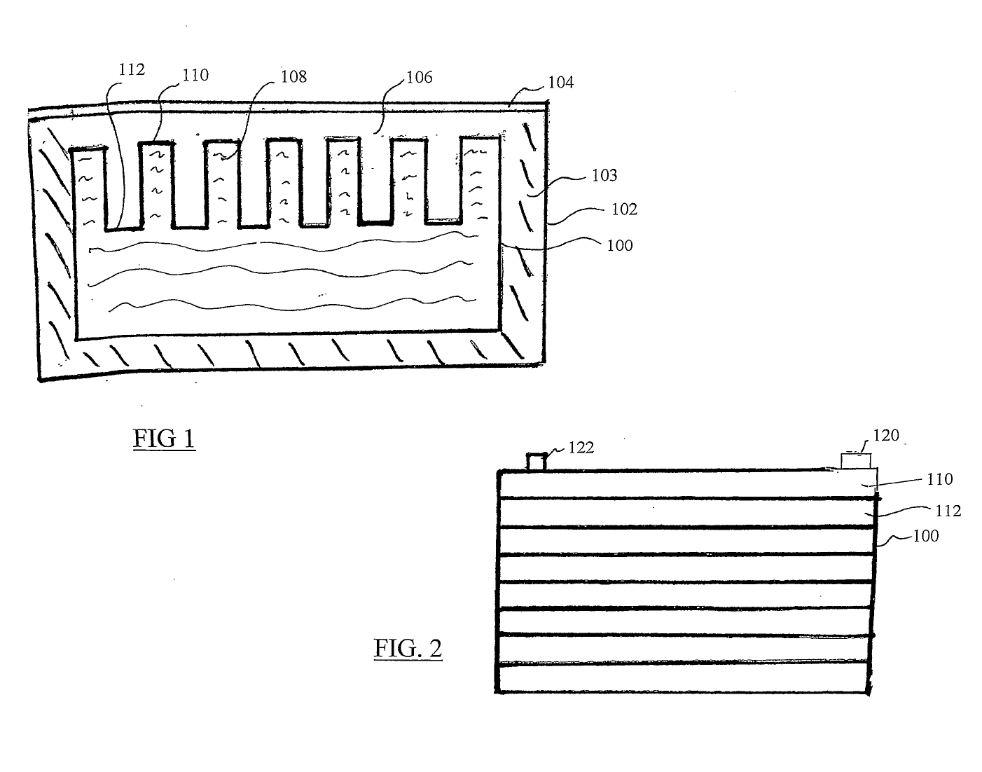

FIG. 1 shows the cross section view of the water tank/solar collector 100 with an insulating box 102 filled with insulation 103 surrounding three sides of the tank/collector 100, with a glass covering 104 to allow the energy of the sun to enter. The glass 104 could be double glazed or a special kind of glass found in the art that allows the sun's energy to enter but prevents that energy from escaping. The resulting temperature on a sunny day in the space 106 between the glass and the tank/collector 100 is high (approximately 50-70 degrees centigrade) and this heat would be transferred to the water 108 in the tank by means of thermal conduction. The shape of the tank/collector 100 with ridges 110 is to increase the surface area exposed to the heat and therefore increase the speed and efficiency of heat transfer. Some heat transfer could also be from radiation of the sun's energy onto the ridges 110 and indentations 112.

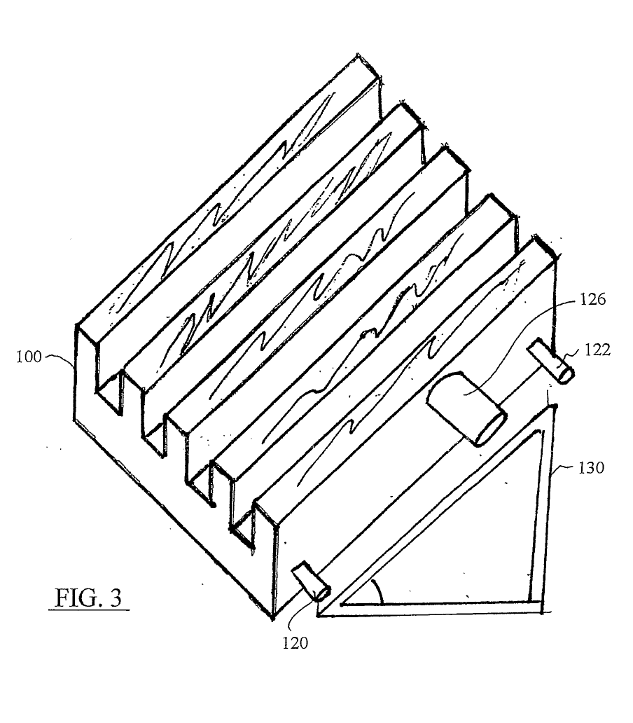

FIG. 2 shows the plan view of the water tank/solar collector 100 where the ridges 110 and indentations 112 are alternate.

There is a pipe 120 leading from a source of cool water into the water tank/solar collector 100 and a pipe 122 leading out heated water from the water tank/solar collector 100.

FIG. 3 shows the perspective view of the water tank/solar collector 100 including the intake cool water pipe 120 at a low point on the tank and the output hot water pipe 122 at a high point on the tank when the water tank/solar collector 100 is inclined. The inclination could be as a result of the water tank/solar collector 100 resting on inclining roof tiles or on an inclined stand 130.

The water tank/solar collector 100 could be supported at an angle of about 45 degrees so the absorption of energy from the sun would be at a maximum average. A convenient place for the water tank/solar collector 100 would be on a sloping roof tile.

An electric element 126 could be affixed into the side of the tank. The electrical element 126 would be for use when there is insufficient exposure to solar energy.

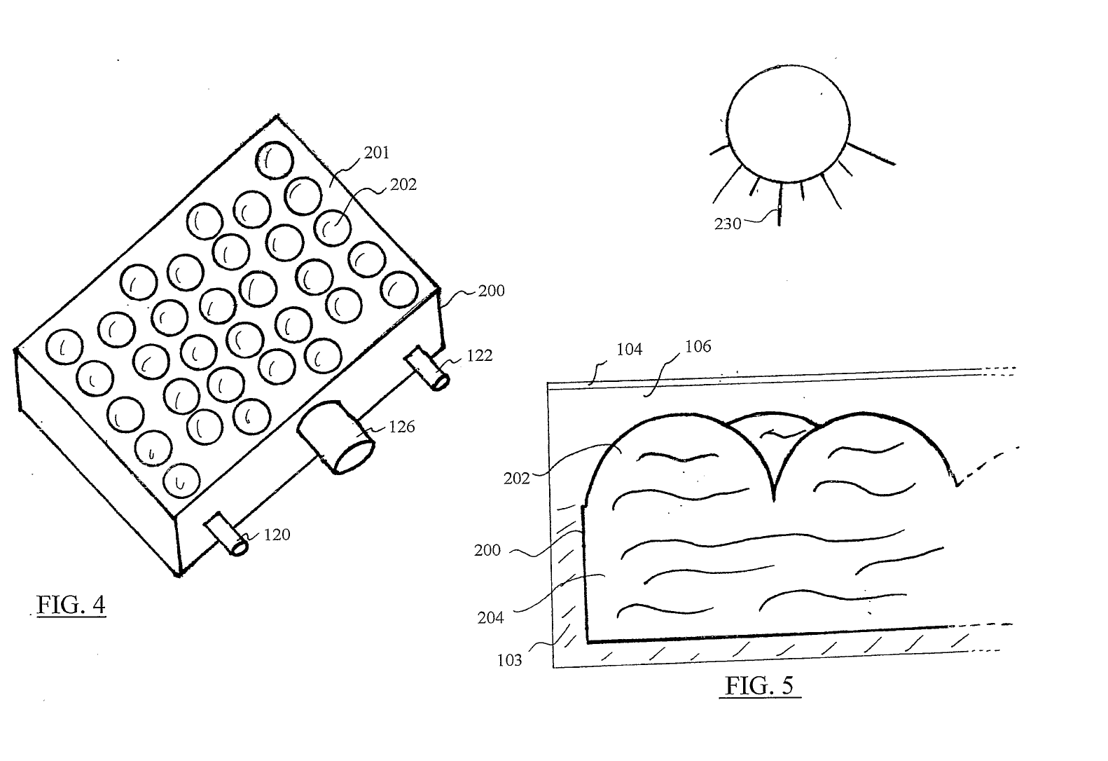

FIG. 4 shows a cuboid shaped water tank/solar collector 200 having embedded in the upper face 201, semi-spherical bodies 202. There is piping 120 near the lower end of the water tank/solar collector 200 for the supply of unheated water to the water tank/solar collector 200. There is piping 122 near the upper end of the water tank/solar collector 200 for the supply heated water to users.

An electrical heating element 126 is installed in the water tank/solar collector 200 for supplementary energy to heat the water in the water tank/solar collector 200 when solar energy is insufficient.

The material of the upper face 201 and of the spheres 202 could be metal, glass, plastic or polymers or a combination of these materials, in order to aid the transfer solar energy from the exterior of the water tank/solar collector 200 to the water inside the water tank.

FIG. 5 shows a cross sectional and expanded view of a portion of the water tank/solar collector 200 and a portion of the semi-spherical spheres 202. Solar energy 230 passes through the glass covering 104 entering the space 106 between the glass 104 and the semi-spherical spheres 202. When the semi-spherical spheres 202 are made of glass the sun's radiated energy enters the water 204 directly and the water 204 is heated as the radiated energy is converted to heat energy. This radiated energy transferred to the water 204 would be in addition to the conducted energy transferred to the water 204 from the heat formed from the greenhouse effect of the sun's rays 230 entering the space 106 through the glass 104.

The water tank/solar collector 200 is surrounded by insulation 103 in order to preserve the accumulated heat in the water at times when the sun energy does not reach the water tank/solar collector 200, namely when there are clouds or at night.

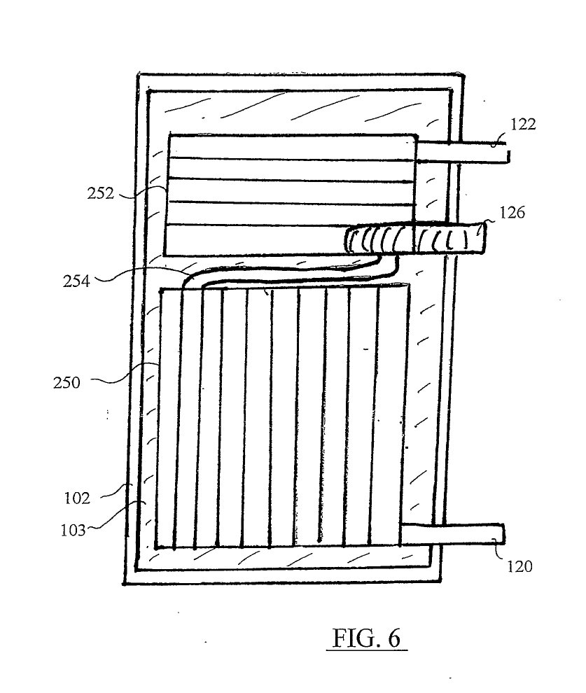

FIG. 6 shows another embodiment of this invention, namely more than one water tank/solar collector joined by a pipe. The first water tank/solar collector 250 is joined to the second water tank/solar collector 252 by pipe 254. Both water tank/solar collectors would be in an insulated container 102 containing insulation 103 and covered with glass FIG. 1 104. The pipe 254 could be made of an efficient thermal conductor like a metal, to add to the heat transfer to the water as the water passes from the first and lower water tank/solar collector 250 to the second and higher water tank/solar collector 252 during the heating process. The intake cool water pipe 120 is at the lower end of the two tanks 250 and 252 when the two tanks 250 and 252 are supported by an incline. The heated water exits from the upper end of the two tanks 250 and 252 through the pipe 122. There is an electrical water heating element 126 in the second and higher water tank/solar collector 252.

The present invention is not intended to be limited to the embodiments described above, but to encompass any and all embodiments within the scope of the following claims.

What is claimed:

1. A water tank/solar collector comprising;
a. an insulated container with an open upper face,
b. a glass sheet covering said open upper face,
c. a tank for holding water inside said container, with an upper face made of alternate ridges and indentations;
d. a pipe connected to the lower portion of said tank for the intake of cool water,
e. a pipe connected to the upper portion of said tank for the output of heated water,
f. whereby water in said tank is heated by solar energy passing through said glass and resultant heat energy transferring to said water.

2. A water tank/solar collector as claimed in claim 1 wherein said container is supported on a sloping surface at an angle between 30° and 60° from the horizontal and facing substantially in a southerly direction.

3. A water tank/solar collector as claimed in claim 1 further comprising an electrical water heating element inserted in said tank.

4. A water tank/solar collector as claimed in claim 1 wherein said ridges are semi-spherical.

5. A water tank/solar collector as claimed in claim 1 wherein said upper face of said tank is made of one of the following list of materials namely, metal, glass, plastic, polyurethane compounds, polypropylene or polypropene, also known as PP, polymethyl methacrylate, also known as PMMA and also known as acrylic glass, and polyvinylidene difluoride, also known as PVDF.

6. A water tank/solar collector as claimed in claim 5 wherein said upper face of said tank is made of a combination of at least two of said list of materials.

7. A water tank/solar collector comprising;
a. an insulated container with an open upper face,
b. a glass sheet covering said open upper face,
c. a tank for holding water inside said container, with an upper face made of semi-spherical spheres,
d. a pipe connected to the lower portion of said tank for the intake of cool water,
e. a pipe connected to the upper portion of said tank for the output of heated water,
f. whereby water in said tank is heated by solar energy passing through said glass and resultant heat energy transferring to said water.

8. A water tank/solar collector as claimed in claim 7 wherein said container is supported on a sloping surface at an angle between 30° and 60° from the horizontal and facing substantially in a southerly direction.

9. A water tank/solar collector as claimed in claim 7 further comprising an electrical water heating element inserted in said tank.

10. A water tank/solar collector as claimed in claim 7 wherein said semi-spherical spheres are alternate ridges and indentations.

11. A water tank/solar collector as claimed in claim 7 wherein said upper face of said tank is made of one of the following list of materials namely, metal, glass, plastic, polyurethane compounds, polypropylene or polypropene, also known as PP, polymethyl methacrylate, also known as PMMA and also known as acrylic glass, and polyvinylidene difluoride, also known as PVDF.

12. A water tank/solar collector as claimed in claim 11 wherein said upper face of said tank is made of a combination of at least two of said list of materials.

13. A water tank/solar collector comprising;
a. an insulated container with an open upper face,
b. a glass sheet covering said open upper face,
c. a plurality of tanks for holding water inside said container, with upper faces made of alternate ridges and indentations,
d. a pipe connecting said tanks leading from top portion of lower tank to bottom portion of next tank higher,
e. a pipe connected to the lowest said tank for the intake of cool water,
f. a pipe connected to the upper-most tank for the output of heated water,
g. whereby water in said tanks is heated by solar energy passing through said glass and resultant heat energy transferring to said water.

14. A water tank/solar collector as claimed in claim 13 wherein said container is supported on a sloping surface at an angle between 30° and 60° from the horizontal and facing substantially in a southerly direction.

15. A water tank/solar collector as claimed in claim 13 further comprising an electrical water heating element inserted in at least one said tank.

16. A water tank/solar collector as claimed in claim 13 wherein said ridges are semi-spherical.

17. A water tank/solar collector as claimed in claim 13 wherein said upper face of said tanks is made of one of the following list of materials namely, metal, glass, plastic, polyurethane compounds, polypropylene or polypropene, also known as PP, polymethyl methacrylate, also known as PMMA and also known as acrylic glass, and polyvinylidene difluoride, also known as PVDF.

18. A water tank/solar collector as claimed in claim 17 wherein said upper face of said tanks is made of a combination of at least two of said list of materials.
